(19) United States
(12) Patent Application Publication
(10) Pub. No.: US 2026/0090548 A1
(43) Pub. Date: Apr. 2, 2026

(54) AQUEOUS AGROCHEMICAL FORMULATIONS COMPRISING BACTERIAL SPORES

(71) Applicant: BASF SE, Ludwigshafen (DE)

(72) Inventors: Ulrike Malang, Limburgerhof (DE); Marco Kuhns, Limburgerhof (DE); Deborah Lynn Neethling, Limburgerhof (DE)

(21) Appl. No.: 19/410,481

(22) Filed: Dec. 5, 2025

Related U.S. Application Data
(62) Division of application No. 17/612,103.

(30) Foreign Application Priority Data
Jun. 19, 2019 (EP) 19181291.6

(51) Int. Cl. A01N 63/23; A01N 25/04; A01N 63/20; A01N 63/22; A01N 63/25; A01P 1/00

(52) U.S. Cl. CPC A01N 63/23; A01N 25/04; A01N 63/20; A01N 63/22; A01N 63/25; A01P 1/00

(57) ABSTRACT

Process for making liquid dispersion formulations comprising
a) at least one type of bacterium spores,
b) an aqueous continuous phase comprising at least one glycol, wherein said glycol is comprised in the formulation in a weight amount that exceeds the weight amount of water,
c) optionally at least one surface active compound S, and
d) optionally further auxiliaries,
A. providing a solid powder of Bacterium spores,
B1. dispersing said spores in a continuous phase comprising at least one glycol, wherein the weight ratio of said at least one glycol to water is below or equal to 1:1,
B2. adding further glycol to the dispersion obtained in step B1. to obtain a ratio of said at least one glycol to water from 4:1 to 1.2:1,
C. adding at least one surfactant S,
D. optionally adding at least one thickener,
E. optionally adding further auxiliaries,
wherein steps C, D and E can be carried out at any time during the process.

### CROSS-REFERENCE TO RELATED APPLICATIONS

This is a divisional of U.S. patent application Ser. No. 17/612,013, filed Nov. 17, 2021, which is the U.S. national phase of International Application No. PCT/EP2020/065773, filed Jun. 8, 2020, which claims the benefit of European Patent application Ser. No. 19/181,291.6, filed on Jun. 19, 2019.

The present invention is directed to Process for making liquid dispersion formulations comprising
a) At least one type of bacterium spores,
b) An aqueous continuous phase comprising at least one glycol, wherein said glycol is comprised in the formulation in a weight amount that exceeds the weight amount of water,
c) optionally at least one surface active compound S, and
d) Optionally further auxiliaries,
comprising the following steps:
A. Providing a solid powder of Bacterium spores,
B1. Dispersing said spores in a continuous phase comprising at least one glycol, wherein the weight ratio of said at least one glycol to water is below or equal to 1:1,
B2. Adding further glycol to the dispersion obtained in step B1. to obtain a ratio of said at least one glycol to water from 4:1 to 1.2:1,
C. Optionally adding at least one surfactant S,
D. Optionally adding at least one thickener,
E. Optionally adding further auxiliaries,
Wherein steps C), D) and E) can be carried out at any time during the process.

Another aspect of the invention are liquid dispersion formulations comprising
a) At least one type of bacterium spores,
b) An aqueous continuous phase comprising at least one glycol,
c) Optionally at least one surfactant S,
d) Optionally further auxiliaries,
wherein said bacterium spores are dispersed in the continuous phase and wherein the formulation comprises at least 40 wt % of said at least one glycol based on the formulation, and wherein the formulation comprises at least 15% but maximally 40% of water.

In another aspect, the present invention is directed to aqueous agrochemical formulations comprising at least one active ingredient and xanthan gum, wherein said formulation comprises less than 50 wt % of water.

Biocontrol agents, also referred to as “microbials” or “biologicals” play an increasingly important role for protecting crops against various pests. In particular Bacillus species are well known for fungicidal, insecticidal and nematicidal activity. Such biologicals are often applied as aqueous formulations of the respective spores.

However, formulations of such bacterium spores tend to decompose, to agglomerate and/or to develop undesirable odor.

US 2017/0347663 discloses non-aqueous formulations of Bacillus amyloliquefaciens.

US 2011/0033436 discloses aqueous formulations of spores comprising 10 to 90% of water miscible solvents like glycol.

It was one objective of the present invention to provide processes for making aqueous formulations of bacterium spores that yield stable formulations that are easy to handle and to spray.

It was another objective of the present invention to provide aqueous formulations of bacterium spores that are stable and do not agglomerate.

The objective has been achieved by processes for making liquid dispersion formulations comprising
a) At least one type of bacterium spores,
b) An aqueous continuous phase comprising at least one glycol, wherein said glycol is comprised in the formulation in a weight amount that exceeds the weight amount of water,
c) optionally at least one surface active compound S, and
d) Optionally further auxiliaries,
comprising the following steps:
A. Providing a solid powder of Bacterium spores,
B1. Dispersing said spores in a continuous phase comprising at least one glycol, wherein the weight ratio of said at least one glycol to water is below or equal to 1:1, preferably below 1:1.5
B2. Adding further glycol to the dispersion obtained in step B1. to obtain a ratio of said at least one glycol to water from 4:1 to 1.2:1,
C. Optionally Adding at least one surfactant S,
D. Optionally adding at least one thickener,
E. Optionally adding further auxiliaries,
Wherein steps C), D) and E) can be carried out at any time during the process.

In one embodiment processes for making liquid dispersion formulations comprise the following steps
a) At least one type of bacterium spores,
b) An aqueous continuous phase comprising at least one glycol, wherein said glycol is comprised in the formulation in a weight amount that exceeds the weight amount of water,
c) at least one surface active compound S, and
d) Optionally further auxiliaries,
comprising the following steps:
A. Providing a solid powder of Bacterium spores,
B1. Dispersing said spores in a continuous phase comprising at least one glycol, wherein the weight ratio of said at least one glycol to water is below or equal to 1:1, preferably below 1:1.5
B2. Adding further glycol to the dispersion obtained in step B1. to obtain a ratio of said at least one glycol to water from 4:1 to 1.2:1,
C. Adding at least one surfactant S,
D. Optionally adding at least one thickener,
E. Optionally adding further auxiliaries,
Wherein steps C), D) and E) can be carried out at any time during the process.

The objective has further been achieved by liquid dispersion formulations comprising
a) At least one type of bacterium spores,
b) An aqueous continuous phase comprising at least one glycol,
c) optionally at least one surface active compound S,
d) Optionally further auxiliaries,
wherein said bacterium spores are dispersed in the continuous phase and wherein the formulation comprises glycol in a weight amount that exceeds the weight amount of water comprised in said formulation.

In one preferred embodiment liquid dispersion formulations comprise
a) At least one type of bacterium spores,
b) An aqueous continuous phase comprising at least one glycol,
c) Optionally at least one surfactant S,
d) Optionally further auxiliaries,
wherein said bacterium spores are dispersed in the continuous phase and wherein the formulation comprises at least 40 wt % of said at least one glycol based on the formulation and wherein the formulation comprises at least 15% but maximally 40% of water.

Formulations according to the invention comprise at least one type of bacterium spores.

Suitable spores include those of Bacillus subtilis, Bacillus velezensis, Bacillus amyloliquefaciens, Bacillus firmus, Bacillus pumilus, Bacillus simplex, Paenibacillus polymyxa, Bacillus megaterium, Bacillus aryabhattai, Bacillus thuringiensis, Bacillus megaterium, Bacillus aryabhattai, Bacillus altitudinis, Bacillus mycoides, Bacillus toyonensis, Bacillus safensis, Bacillus methylotrophicus, Bacillus mojavensis, Bacillus psychrosaccharolyticus, Bacillus galliciensis, Bacillus lentus, Bacillus siamensis, Bacillus tequilensis, Bacillus firmus, Bacillus aerophilus, Bacillus altitudinis, Bacillus stratosphericus, Bacillus velezensis, Brevibacillus brevis, Brevibacillus formosus, Brevibacillus laterosporus, Brevibacillus nitrificans, Brevibacillus agri, Brevibacillus borstelensis, Lysinibacillus xylanilyticus, Lysinibacillus parviboronicapiens, Lysinibacillus sphaericus, Lysinibacillus fusiformis, Lysinibacillus boronitolerans, Paenibacillus alvei, Paenibacillus Validus, Paenibacillus amylolyticus, Paenibacillus lautus, Paenibacillus peoriae, Paenibacillus tundrae, Paenibacillus daejeonensis, Paenibacillus alginolyticus, Paenibacillus pini, Paenibacillus odorifer, Paenibacillus endophyticus, Paenibacillus xylanexedens, Paenibacillus illinoisensis, Paenibacillus thiaminolyticus, Paenibacillus barcinonensis, Sporosarcina globispora, Sporosarcina aquimarina, Sporosarcina psychrophila, Sporosarcina pasteurii, Sporosarcina saromensis.

Preferred spores are those of Bacillus subtilis, Bacillus velezensis, Bacillus amyloliquefaciens, Bacillus firmus, Bacillus pumilus, Bacillus simplex, Paenibacillus polymyxa and Bacillus thuringiensis.

In one preferred embodiment, the spores are of Bacillus amyloliquefaciens MBI600, Bacillus amyloliquefaciens AP188, Bacillus subtilus BU1814, Bacillus pumilus F33, Bacillus simplex ABU288, Paenibacillus polymyxa LU17007, Bacillus firmus I-1582, Bacillus thuringiensis EX-297512, Bacillus subtilus GB03, Bacillus pumilus GB34, Pasteuria nishizawae Pnl, Bacillus amyloliquefaciens F727, Bacillus amyloliquefaciens PTA-4838, Bacillus amyloliquefaciens D747, Bacillus amyloliquefaciens FZB24, Bacillus amyloliquefaciens TJ1000, Bacillus licheniformis DSM 32154.

Said bacterium spores are dispersed in a continuous phase that comprises water and at least one glycol.

In the context of this application the term “glycol” shall be understood to include organic diols, their oligomers (e.g. oligoalkylene glycol like oligoethylene glycol), polymers (e.g. polyalkylene glycol like polyethylene glycol) as well as glycerol.

Whenever reference is made herein to “glycol”, this shall include glycerol.

Preferred glycols are ethylene glycol, 1,2-propylene glycol, 1,3 propylene glycol, 1,2-butylene glycol, diethylene glycol, triethylene glycol, polyethylene glycol having an average molecular mass Mn of 150 to 600 g/mol, preferably 180 to 250 g/mol (average molar mass of polyalkylene glycol herein are calculated from hydroxyl-number as determined according to DIN 53240), and glycerol.

More preferably, said glycol is selected from 1,2-propylene glycol, ethylene glycol, diethylene glycol, 1,2-butylene glycol, polyethylene glycol having an average molecular mass Mn of 150 to 600 g/mol and glycerol.

Especially preferably, said glycol is 1,2-propylene glycol or glycerol.

Especially preferably, said glycol is 1,2-propylene glycol.

In another preferred embodiment, said glycol is triethylene glycol.

In another preferred embodiment, said glycol is polyethylene glycol having an average molecular mass Mn of 150 to 600 g/mol, preferably 180 to 250 g/mol.

In another preferred embodiment, said glycol is triethylene glycerol.

Formulations according to the invention comprise 40 to 90 wt % of at least one glycol, based on the formulation.

In one embodiment, formulations according to the invention comprise 50 to 90 wt % of at least one glycol. In another embodiment, formulations according to the invention comprise 50 to 80 wt % of at least one glycol. In another embodiment, formulations according to the invention comprise 60 to 75 wt % of at least one glycol, in each case based on the formulation.

According to the invention, formulations according to the invention have an excess of said at least one glycol over water. Preferably, formulations according to the invention comprise at least one glycol and water with a weight ratio of said at least one glycol to water in the range from 4:1 to 1.2:1.

In any case, formulations according to the invention need to comprise at least 15 wt % of water based on the formulation.

In one preferred embodiment, formulations according to the invention comprise at least one surfactant S (also referred to as “surface active compound S”).

Preferably, surfactant S is selected from nonionic or anionic surfactants.

In one especially preferred embodiment, formulations according to the invention comprise at least one nonionic surfactant S.

The nonionic surfactant S is preferably a low foaming nonionic surfactant.

Suitable nonionic surfactants include alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. For example, ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Said at least one nonionic surfactant S is in one embodiment at least one polyalkyleneoxide PAO.

In one embodiment, polyalkyleneoxides PAO comprise blocks of polyethylene oxide (PEO) at the terminal positions, whereas blocks of polyalkylene oxides different from ethylene oxide like polypropylene oxide (PPO), polybutylene oxide (PBO) and poly-THF (pTHF) are comprised in central positions.

In one embodiment polyalkyleneoxides PAO have the structure PEO-PPO-PEO, PPO-PEO-PPO, PEO-PBO-PEO or PEO-pTHF-PEO.

Suitable polyalkyleneoxides PAO normally comprise a number average of 1.1 to 100 alkyleneoxide units, preferably 5 to 50 units.

In one embodiment nonionic surfactant S has a molar mass of 500 to 6000 g/mol.

In one embodiment polyalkyleneoxides PAO are endcapped on one side or both sides with an alkyl or aryl group (i.e. etherified with the corresponding alcohol).

In one embodiment, nonionic surfactants are ethoxylates of a sugar alcohol. This includes ethoxylates of sugar alcohols that are further modified, for example by etherification or esterification of terminal OH groups.

In one embodiment, nonionic surfactant S is an ethoxylate of sorbitol.

In one embodiment, nonionic surfactant S is a polyethyleneoxide that is esterified in one or more terminal positions with a fatty acid.

In one embodiment, nonionic surfactant S is a polyethyleneoxide that is esterified in one or more terminal positions with a C₆-C₃₀ fatty acid.

In one embodiment, nonionic surfactant S is an ethoxylate of sorbitol that is esterified in one terminal position with a fatty acid.

In one embodiment, nonionic surfactant S is an ethoxylate of sorbitol that is esterified in one terminal position with a C₆-C₃₀ fatty acid.

In one embodiment, nonionic surfactant S is an ethoxylate of sorbitol that is esterified in one terminal position with a C₆-C₃₀ unsaturated fatty acid.

In one embodiment, nonionic surfactant S is an ethoxylate of sorbitol that is esterified in one terminal position with oleic acid.

In one embodiment ethoxylates of sugar alcohols comprise a number average of 15 to 25 units of ethylene oxide.

In one embodiment, nonionic surfactant S is an ethoxylate of sorbitol comprising a number average of 15 to 25 units of ethyleneoxide and that is esterified in its terminal positions with a C₆-C₃₀ fatty acid, preferably an unsaturated acid, preferably oleic acid.

In one embodiment, nonionic surfactant S is polyoxyethylene(20)-sorbitan-monooleate.

Formulations according to the invention may optionally comprise further auxiliaries, such as further surfactants, dispersants, emulsifiers, wetters, adjuvants, biocides, solubilizers, penetration enhancers, protective colloids, adhesion agents, thickeners, humectants, repellents, attractants, feeding stimulants, compatibilizers, bactericides, anti-foaming agents, colorants, preservatives, tackifiers and binders. The auxiliaries are preferably free of any UV absorber.

Suitable further surfactants are surface-active compounds, such as anionic, cationic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.)

Suitable anionic surfactants include alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable cationic surfactants include quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the pesticides like pesticide P1 on the target. Examples are surfactants, mineral or vegetable oils, and other auxiliaries. Further examples are listed by Knowles, Adjuvants and additives, Agrow Reports DS256, T&F Informa UK, 2006, chapter 5.

In one embodiment, formulations according to the invention comprise 0.01 to 2 wt % of an organic or inorganic thickener. Suitable thickeners include polysaccharides (e.g. xanthan gum, carboxymethylcellulose), inorganic clays (organically modified or unmodified), polycarboxylates, and silicates.

In one embodiment, formulations according to the invention comprise xanthan gum as a thickener. In one preferred embodiment, xanthan gum is comprised in formulations according to the invention in an amount of 0.01 to 0.4 wt %, preferably 0.05 to 0.15 wt %, based on the formulation.

In one embodiment, formulations according to the invention comprise a Magnesium Aluminum Silicate (like for example montmorillonite and/or saponite), bentonites, attapulgites or silica as a thickener. In one preferred embodiment, a Magnesium Aluminum Silicate (like for example montmorillonite, saponite), bentonite, attapulgite or silica is comprised in formulations according to the invention in an amount of 0.1 to 2 wt %, preferably to 0.5 to 1.5 wt %, based on the formulation.

Suitable anti-foaming agents are silicones, long chain alcohols, and salts of fatty acids. In one embodiment, formulations according to the invention contain 0.01 to 1.0 wt % of an anti-foaming agent, for example of a silicone anti-foaming agent.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

In one embodiment, formulations according to the invention comprise
a) 1 to 80 wt % of at least one type of bacterium spores,
b) 20 to 99 wt % of an aqueous continuous phase comprising at least one glycol,
c) Optionally at least one surfactant S,
d) Optionally further auxiliaries,
wherein said bacterium spores are dispersed in the continuous phase and wherein the formulation comprises at least 40 wt % of said at least one glycol based on the formulation.

In one embodiment, formulations according to the invention comprise
a) 1 to 80 wt % of at least one type of bacterium spores,
b) 20 to 98.9 wt % of an aqueous continuous phase comprising at least one glycol,
c) 0.1 to 10 wt % at least one nonionic surfactant S,
d) Optionally further auxiliaries,
wherein said bacterium spores are dispersed in the continuous phase and wherein the formulation comprises at least 40 wt % of said at least one glycol based on the formulation.

In one embodiment, formulations according to the invention comprise
a) 1 to 80 wt % of at least one type of bacterium spores,
b) 20 to 98.9 wt % of an aqueous continuous phase comprising at least one glycol,
c) 0.1 to 10 wt % at least one nonionic surfactant S,
d) Up to 5 wt % further auxiliaries,
wherein said bacterium spores are dispersed in the continuous phase and wherein the formulation comprises at least 40 wt % of said at least one glycol based on the formulation.

In one embodiment, formulations according to the invention comprise
a) 1 to 80 wt % of at least one type of bacterium spores,
b) 20 to 98.8 wt % of an aqueous continuous phase comprising at least one glycol,
c) 0.1 to 10 wt % at least one nonionic surfactant S,
d) 0.1 to 5 wt % further auxiliaries, including 0.1 to 2 wt % of a thickener,
wherein said bacterium spores are dispersed in the continuous phase and wherein the formulation comprises at least 40 wt % of said at least one glycol based on the formulation.

In one embodiment, formulations according to the invention comprise
a) 1 to 80 wt % of at least one type of bacterium spores,
b) 20 to 98.8 wt % of an aqueous continuous phase comprising at least one glycol,
c) 0.1 to 10 wt % at least one nonionic surfactant S,
d) 0.1 to 5 wt % further auxiliaries, including 0.01 to 0.4 wt % of xanthan gum,
wherein said bacterium spores are dispersed in the continuous phase and wherein the formulation comprises at least 40 wt % of said at least one glycol based on the formulation.

In case in any of the formulations given herein the amount of the shares of each component exceeds 100%, the maximum amount of the continuous phase shall be reduced accordingly such that the amount of the shares of each component equals 100 wt %.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In formulations according to the invention, bacterium spores are preferably present in the formulations in the form of solid particles having an average particle size of 1 to 25 μm, preferably 1 to 10 μm, more preferably 1 to 8 μm (determined according to light scattering method in liquid dispersion according to CIPAC method 187).

The number of colony forming units (cfu) in formulations according to the invention is preferably in the range from 5 E+9 cfu/ml to 1 E+11 cfu/ml. The determination of colony forming units follows standard microbiological procedures as described in the experimental section.

Formulations according to the invention preferably have a viscosity of 80 to 250 mPas at a shear rate of 100 s⁻¹ (rotational rheometer acc. CIPAC method 192).

In one embodiment formulations according to the invention may comprise one or more further agrochemical active ingredients

Another aspect of the present invention are processes for making formulations comprising
a) at least one type of bacterium spores,
b) An aqueous continuous phase comprising at least one glycol, wherein said glycol is comprised in the formulation in a weight amount that exceeds the weight amount of water,
c) optionally at least one surface active compound S, and
d) Optionally further auxiliaries.

Preferably, such formulations comprise at least 40 wt % of said at least one glycol based on the formulation and wherein the formulation comprises at least 15% but maximally 40% of water

To prepare such formulations, bacterium technical grade active ingredient in form of its spore powder is dispersed in the liquid continuous phase or part of it (as premix). For dispersion and deagglomeration of spore aggregates, a high-shear mixing equipment (e.g. a Siefer colloid mill, or a Silverson, Ultraturrax or Polytron mixer) can be used. Additives like wetting agents, surfactants, dispersants, antifoams, thickeners, stabilizers, biocides etc. can be added depending on their shear stability before or after introduction of Bacillus

Processes for making such formulations normally comprise the following steps:
A) Providing a solid powder of Bacterium spores,
B) Dispersing said spores in a continuous phase comprising at least one glycol,
C) Adding at least one surfactant S,
D) Optionally adding at least one thickener,
E) Optionally adding further auxiliaries,
Wherein steps C), D) and E) can be carried out at any time during the process.

Preferably such processes according to the invention comprise the following steps:
A. Providing a solid powder of Bacterium spores,
B1. Dispersing said spores in a continuous phase comprising at least one glycol, wherein the weight ratio of said at least one glycol to water is below or equal to 1:1, or preferably below 1:1.5,
B2. Adding further glycol to the dispersion obtained in step B1. to obtain a ratio of said at least one glycol to water from 4:1 to 1.2:1,
C. Adding at least one surfactant S,
D. Optionally adding at least one thickener,
E. Optionally adding further auxiliaries,
Wherein steps C), D) and E) can be carried out at any time during the process.

All components and all embodiments suitable for liquid dispersion formulations described above are equally suitable for processes according to the invention.

Another aspect of the present invention are methods of combating fungi, insects or nematodes using formulations according to the invention

The present invention furthermore relates to a method of controlling phytopathogenic fungi and/or undesirable vegetation and/or undesired insect or mite attack and/or nematodes and/or for regulating the growth of plants, wherein the formulation according to the invention or prepared according to the invention is allowed to act on the respective pests, their environment or the crop plants to be protected from the respective pest, on the soil and/or on undesired plants and/or on the crop plants and/or on their environment. The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such genetic modifications also comprise posttranslational modifications of proteins, oligo- or polypeptides, for example by means of glycosylation or binding of polymers such as, for example, prenylated, acetylated or farnesylated residues or PEG residues.

The term “crop” refers to both, growing and harvested crops.

The term “plant” includes cereals, e.g. durum and other wheat, rye, barley, triticale, oats, rice, or maize (fodder maize and sugar maize/sweet and field corn); beet, e.g. sugar beet or fodder beet; fruits, such as pomes, stone fruits or soft fruits, e.g. apples, pears, plums, peaches, nectarines, almonds, cherries, papayas, strawberries, raspberries, blackberries or gooseberries; leguminous plants, such as beans, lentils, peas, alfalfa or soybeans; oil plants, such as rapeseed (oilseed rape), turnip rape, mustard, olives, sunflowers, coconut, cocoa beans, castor oil plants, oil palms, ground nuts or soybeans; cucurbits, such as squashes, pumpkins, cucumber or melons; fiber plants, such as cotton, flax, hemp or jute; citrus fruit, such as oranges, lemons, grapefruits or mandarins; vegetables, such as eggplant, spinach, lettuce (e.g. iceberg lettuce), chicory, cabbage, asparagus, cabbages, carrots, onions, garlic, leeks, tomatoes, potatoes, cucurbits or sweet peppers; lauraceous plants, such as avocados, cinnamon or camphor; energy and raw material plants, such as corn, soybean, rapeseed, sugar cane or oil palm; tobacco; nuts, e.g. walnuts; pistachios; coffee; tea; bananas; vines (table grapes and grape juice grape vines); hop; sweet leaf (also called Stevia); natural rubber plants or ornamental and forestry plants, such as flowers (e.g. carnation, petunias, geranium/pelargoniums, pansies and impatiens), shrubs, broad-leaved trees (e.g. poplar) or evergreens, e.g. conifers; eucalyptus; turf; lawn; grass such as grass for animal feed or ornamental uses. Preferred plants include potatoes sugar beets, tobacco, wheat, rye, barley, oats, rice, corn, cotton, soybeans, rapeseed, legumes, sunflowers, coffee or sugar cane; fruits; vines; ornamentals; or vegetables, such as cucumbers, tomatoes, beans or squashes.

The term “cultivated plants” is to be understood as including plants which have been modified by mutagenesis or genetic engineering in order to provide a new trait to a plant or to modify an already present trait.

Another aspect of the present invention are methods of treating seeds using formulations according to the invention or prepared according to the invention.

The term “seed treatment” comprises all suitable seed treatment techniques known in the art, such as seed dressing, seed coating, seed dusting, seed soaking, seed pelleting, and in-furrow application methods. Preferably, the seed treatment application of the active compound is carried out by spraying or by dusting the seeds before sowing of the plants and before emergence of the plants.

The invention also comprises seeds coated with or containing the active formulation. The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re) planted, it may absorb the active ingredient.

Suitable seed is for example seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

The invention therefore also relates to seed to which a formulation of the invention has been applied. The amount of the active ingredients of formulations the invention or will in general vary from 0.1 g to 10 kg per 100 kg of seed, preferably from 1 g to 5 kg per 100 kg of seed, in particular from 1 g to 1000 g per 100 kg of seed.

Formulations according to the invention are easy and economical to make and are environmentally friendly and non-toxic.

Formulations according to the invention can be prepared with small average particle sizes, low viscosity and with well dispersed bacterium spores.

Formulations according to the invention are very stable and have a low tendency to undergo sedimentation or to form agglomerates of the bacterium spores. Formulations according to the invention show little increase of viscosity over time.

Formulations according to the invention are stable against decomposition and have a low tendency to develop discoloration or undesired odor and are easy to handle and to spray.

Formulations according to the invention can be distributed homogeneously end evenly on the target and show excellent biological performance.

Processes according to the invention are easy and economical to carry out.

Processes according to the invention are environmentally friendly.

Processes according to the invention yield formulations with small average particle sizes and with well dispersed bacterium spores.

Processes according to the invention yield formulations that have a low viscosity.

Processes according to the invention yield formulations that are very stable and have a low tendency to undergo sedimentation or to form agglomerates of the bacterium spores and that show little increase of viscosity over time.

Processes according to the invention yield formulations that can be distributed homogeneously end evenly on the target and show excellent biological performance.

Processes according to the invention yield formulations that are easy to handle and to spray.

Another aspect of the present invention are formulations comprising at least one active ingredient and xanthan gum, wherein said formulation comprises less than 50 wt % of water. In other embodiments, such formulations comprise xanthan gum and less than 40 wt % or less than 30 wt % of water. In one embodiment said active ingredient is an agrochemical active ingredient.

As it is known to the skilled person, xanthan gum requires the presence of sufficiently large amounts of water to be able to swell and perform its function as a thickening agent. In was surprisingly found that contrary to the common prejudice, xanthan gum can act as a thickening agent even in formulations that comprise less the 50 wt % or even less than 40 or 30 wt % of water.

Xanthan gum is normally present in such formulations in amounts from 0.01 to 0.4 wt %, preferably 0.05 to 0.2 wt %.

Such formulations may further comprise surfactants and further auxiliaries as defined above.

### EXAMPLES

### Materials Used:

Bacillus amyloliquefaciens MBI 600 NRRL B-50595 spore powder with a viable spore content of approximately 1 E+12 cfu/g.
Bacillus subtilis BU 1814 ATCC PTA-11857 spore powder
Ethylene glycol
1,2-Propylene glycol
1,3-Propyene glycol
Diethylene glycol
Triethylene glycol
PEG200 (polyethylene glycol with an average molar mass of 200 g/mol (from OH number)).
Glycerol (Propane-1,2,3-triol)
Surfactant A (Polyoxyethylene (20) sorbitan monooleate) Silicone antifoam emulsion
Xanthan gum powder
Magnesium Aluminum Silicate A: Magnesium Aluminum Silicate NF Type IA
Magnesium Aluminum Silicate B: Magnesium Aluminum Silicate NF Type IA, non-irradiated
Biocide solution (containing Methylisothiazolinone and Benzisothiazolinone, 250 ppm each)

The analysis of colony forming units follows standard microbiological procedures (e.g. FDA Bacteriological Analytical Manual, Chapter 3, Aerobic Plate Count). First, a dilution series of the sample is produced and the dilutions are plated onto agar and incubation at a characteristic growth temperature. Upon incubation, colonies form and are counted for all plates with 20 to 200 colonies. Each colony is defined to represent one initial viable spore or cell. The count is multiplied by the dilution factor to obtain the number of cfu per gram or milliliter of the original sample.

### Examples 1a to 1h: Preparation of Aqueous Formulations of Bacterium Spores and Microbiological Stability

Water and glycol were mixed and half of the antifoam was added to the mixture. The Bacillus amyloliquefaciens spores were added under stirring and then homogenized with a rotor-stator equipment. The formulation samples were finalized by adding the second half of antifoam and in case of recipe 1d and 1h the isothiazolinone biocide.

All formulation samples were evaluated for cfu/g initially. The samples were then stored in an incubator for 12 days at 30° C. and reevaluated for cfu/g and visually. After additional 17 days storage at room temperature (21+−2° C.), all formulation samples were evaluated again. All formulation samples except those containing 500 g/kg of 1,2-propylene glycol or glycerol had developed a strange characteristic scent. In the case of 1,2-propylene glycol the scent was similar to that of alcohol or ketone solvents. In the case of glycerol, the scent was that of decomposed organic matter, and moreover, a reddish color developed in the suspension. From examples 1a to 1h (table 1, amounts given in grams [g]), only the formulations containing 500 g/kg glycol (i.e. propylene glycol or glycerol) (recipes 1c and 1g) can be considered microbiologically stable.

TABLE 1

| Ingredients (g) | Recipe 1a | Recipe 1b | Recipe 1c | Recipe 1d | Recipe 1e |
|---|---|---|---|---|---|
| 1,2-Propylene | 50.00 | 150.00 | 500.00 | 50.00 | |
| glycol | | | | | |
| Glycerol | | | | | 50.00 |
| Biocide (MIT/BIT) | | | | 2.00 | |
| B. amyloliquefaciens MBI600 | 110.00 | 110.00 | 110.00 | 110.00 | 110.00 |
| Silicone Antifoam | 5.00 | 5.00 | 5.00 | 5.00 | 5.00 |
| Water, Deionized | ad 1000 g | ad 1000 g | ad 1000 g | ad 1000 g | ad 1000 g |
| cfu/g initial | 1.1E+11 | 1.7E+11 | 6.3E+10 | 1.3E+11 | 1.3E+11 |
| 12 days @30° C. | | | | | |
| cfu/g | 1.1E+11 | 7.1E+10 | 5.6E+10 | 7.8E+10 | 1.1E+11 |
| visual appearance | homogeneous | homogeneous | homogeneous | homogeneous | reddish color |
| scent | characteristic | | | | gas development. |
| | scent | | | | bad smell |
| 17 days @ 21° C. | | | | | |
| cfu/g | 8.0E+10 | 6.7E+10 | 6.0E+10 | 9.5E+10 | 6.3E+10 |
| visual | homogeneous | homogeneous | homogeneous | homogeneous | reddish color |
| scent | characteristic | characteristic | | characteristic | gas development, |
| | scent | scent | | scent | bad |
| | | | | | smell |

| Ingredients (g) | Recipe 1f | Recipe 1g | Recipe 1h |
|---|---|---|---|
| 1,2-Propylene | | | |
| glycol | | | |
| Glycerol | 150.00 | 500.00 | 50.00 |
| Biocide (MIT/BIT) | | | 2.00 |
| B amyloliquefaciens MBI600 | 110.00 | 110.00 | 110.00 |
| Silicone Antifoam | 5.00 | 5.00 | 5.00 |
| Water, Deionized | ad 1000 g | ad 1000 g | ad 1000 g |
| cfu/g initial | 1.2E+11 | 8.4E+10 | 1.1E+11 |
| 12 days @30° C. | | | |
| cfu/g | 9.4E+10 | 1.0E+11 | 1.4E+10 |
| visual appearance | homogeneous | homogeneous | reddish color |
| scent | | | gas development. bad |
| | | | smell |
| 17 days @ 21° C. | | | |
| cfu/g | 8.8E+10 | 7.5E+10 | 1.3E+10 |
| visual | reddish color | homogeneous | reddish color |
| scent | gas development, bad | | gas development, bad |
| | smell | | smell |

### Examples 2a to 2f: Preparation of Bacillus Spore Dispersions with High Propylene Glycol Content

The samples 2a, 2b, 2c and 2d were prepared as follows: A direct dispersion of Bacillus spore powder in the respective complete mixture of 1,2-propylene glycol and water was carried out. First, water and glycol were mixed, and the spore powder was added and dispersed by stirring and further homogenized by a rotor-stator equipment with a target particle size d50 value of about 2 μm. Without a sufficient amount of water, a sufficient deagglomeration was not possible (2a and 2b), while with increasing water amount (2c and 2d) the deagglomeration with shear becomes much more efficient and at a ratio of water to 1,2-propylene glycol of 1:1 the desired particle size can be reached.

For samples 2e and 2f, a premix of 50 g Bacillus spore powder dispersed and homogenized in a mixture of 199.5 g water and 199.5 g 1,2-propylene glycol was prepared in a first step. The particle size distribution measured for this 11% Bacillus spore premix had a d50 of 2.1 μm and a d90 of 54.2 μm. The final formulation 2e then was prepared by addition of 241.9 g 1,2-propylene glycol to 197.5 g of Bacillus spore premix. In the case of formulation 2f, 0.5 g Xanthan Gum dispersed in 241.9 g of 1,2-propylene glycol were added to 197.5 g of Bacillus spore premix. The sample 2f was stirred for 1h for the Xanthan Gum to hydrate. The initial viscosity increased from 26 to 80 mPas by addition of the Xanthan Gum, showing that even with the low amount of water in this formulation the Xanthan gum could still be hydrated.

After 11 days storage at room temperature, samples 2a and 2b showed phase separation, whereas samples 2c and 2d, with a higher water content and deagglomeration, as well as samples 2e and 2f with a similar water to 1,2-propylene glycol content as 2b, but prepared from a deagglomerated premix were still homogenous. In case of the samples 2c, 2e and 2f, the particle size distribution showed some agglomeration with the d50 value increasing.

After further 52 days room temperature storage, samples 2e and 2f were reevaluated visually. While sample 2e was completely sedimented, sample 2f was still perfectly homogeneous, showing the physical stabilization effect of the Xanthan gum added.

Compositions and properties of examples 2a to 2f are given in table 2 (amounts given in % w/w).

TABLE 2

| Recipe % (wfw) | 2a | 2b | | 2c | |
|---|---|---|---|---|---|
| Bacillus | 5 | 5 | | 5 | |
| amyloliquefaciens | | | | | |
| MBI 600 | | | | | |
| 1,2-Propylene | 95 | 75 | | 60 | |
| glycol | | | | | |
| Water | | 20 | | 35 | |
| Xanthan Gum | | | | | |
| Premix | Not possible | No | | No | |
| initial | | | | | |
| Visual evaluation | fast sedimentation | homogeneous | | homogeneous | |
| D90 (μm) | 68.5 | 65.5 | | 42.7 | |
| D50 (μm) | 33.0 | 28.8 | | 5.11 | |
| viscosity | 97 | 57 | | 119 | |
| (mPas at 100s − 1) | | | | | |
| 11 d RT | | | | | |
| Visual evaluation | flocculated, serum | phase separation, | | homogeneous | |
| | 54% | sediment | | | |
| D90 (μm) | 70.6 | 67.6 | | 46.5 | |
| D50 (μm) | 33.6 | 30.0 | | 13.6 | |
| viscosity | 99 | 58 | | 117 | |
| (mPas at 100s − 1) | | | | | |
| 63 d RT | | | | | |
| Visual evaluation | — | — | | — | |
| Recipe % (w/w) | 2d | 2e | | 2f | |
| Bacillus | 5 | 5 | | 5 | |
| amyloliquefaciens | | | | | |
| MBI 600 | | | | | |
| 1,2-Propylene | 47.5 | 75 | | 75 | |
| glycol | | | | | |
| Water | 47.5 | 20 | | 19.9 | |
| Xanthan Gum | | | | 0.1 | |
| Premix | No | Yes | | Yes | |
| initial | | | | | |
| Visual evaluation | homogeneous | homogeneous | | homogeneous | |
| D90 (μm) | 39.3 | 54 | (Premix) | 54 | (Premix) |
| D50 (μm) | 1.68 | 2.1 | (Premix) | 2.1 | (Premix) |

| | | | |
|---|---|---|---|
| viscosity | 135 | 26 | 80 |
| (mPas at 100s − 1) | | | |
| 11 d RT | | | |
| Visual evaluation | homogeneous | homogeneous | homogeneous |
| D90 (μm) | 40.9 | 56.4 | 60.3 |
| D50 (μm) | 1.8 | 19.6 | 25.8 |
| viscosity | 138.7 | 26 | 88 |
| (mPas at 100s − 1) | | | |
| 63 d RT | | | |
| Visual evaluation | — | completely | homogeneous |
| | | sedimented, | |
| | | redispersible | |

### Examples 3a to 3d: Preparations with and without Spore Premix in Comparison

To show the effect of premix preparation, 1% Bacillus spore dispersions were prepared from two different batches of Bacillus amyloliquefaciens MBI600 powder with and without premix.

The samples 3a and 3c were prepared as follows: A direct dispersion of Bacillus spore powder in the respective complete mixture of 1,2-propylene glycol and water was carried out. First, water and glycol were mixed, and the spore powder was added and dispersed by stirring and further homogenized by a rotor-stator equipment with a target particle size d50 value of about 2 μm. A sufficient deagglomeration was not possible and the samples showed quick sedimentation even directly after preparation.

For samples 3b and 3d, a premix of 15 g Bacillus spore powder dispersed and homogenized in a mixture of 285 g water and 75 g 1,2-propylene glycol was prepared in a first step. The final formulations 3b and 3d then were prepared by addition of the residual 1125 g 1,2-propylene glycol to 375 g of Bacillus spore premix.

For samples 3b and 3d, prepared from a premix, lower particle size values (d50 and d90) could be reached as compared to samples 3a and 3c, where the dispersion was carried out directly in the final 1,2-propylene-glycol to water mixture. Samples 3b and 3d also were homogeneous after preparation in contrast to samples 3a and 3c that displayed quick sedimentation.

Compositions and properties of examples 3a to 3d are given in table 3 (amounts given in % w/w).

TABLE 3

| Recipe % (w/w) | 3a | | 3b | | 3c | | 3d | |
|---|---|---|---|---|---|---|---|---|
| Bacillus amyloliquefaciens | 1 | | 1 | | 1 | | 1 | |
| MBI 600 | | | | | | | | |
| 1,2-Propylene glycol | 80 | | 80 | | 80 | | 80 | |
| Water | 19 | | 19 | | 19 | | 19 | |
| Premix | No | | Yes | | No | | Yes | |
| Spore batch | A | | A | | B | | B | |
| initial | | | | | | | | |
| Visual evaluation | Inhomogeneous, | | homogeneous | | Inhomogeneous, | | homogeneous | |
| | fast sedimentation | | opaque liquid | | fast sedimentation | | opaque liquid | |
| D90 (μm) (with sonication) | 83.6 | (40.4) | 37.2 | (35.2) | 78.6 | (62.1) | 46.1 | (50.7) |
| D50 (μm) (with sonication) | 43.9 | (4.2) | 3.4 | (2.8) | 38.7 | (25.7) | 1.4 | (1.4) |

| | | | | |
|---|---|---|---|---|
| viscosity (mPas at 100s − 1) | 26 | 47 | 26 | 51 |
| cfu/g | 8.1E+9 | 1.4E+10 | 1.7E+10 | 1.8E+10 |

### Examples 4a to 4f: Preparation of Microbiologically and Physically Stable Spore Dispersions

The samples 4a to 4f were prepared as follows: First, a 5% premix of spore powder was dispersed and homogenized with a rotor-stator equipment in a mixture of 77.2 parts of water and 17.9 parts of 1,2-propylene glycol. Then, the remaining amount of 1,2-propylene glycol was added and the sample stirred until homogeneous. In case of samples 4b and 4e, part of the 1,2-propylene glycol was replaced by the surfactant A. In case of 4c and 4f the Xanthan gum thickener in the remaining 1,2-propylene glycol was added to the premix and stirred for one hour. The samples were stored under increased temperature stress for 14 days at 54° C. In case of samples 4a and 4d without Xanthan gum, strong flocculation and accordingly phase separation occurred. Samples 4c and 4f on the contrary stayed 10 homogeneous. The particle size distribution after storage changed slightly, with some soft flocculation (visible or redispersible under sonication). This shows that formulations with a low particle size can be prepared by a premix concept with sufficient amount of water for hydration and kept homogeneous by the addition of Xanthan gum. Surfactant A is compatible with the system but provides no significant advantage over the formulation without any surface active compound. A separate subsample of each formulation 4a to 4f was exposed to 35° C. for 1 week, and the viable spore count in cfu/g evaluated. It did not decrease or increase significantly, and no odor or coloring was developed, showing that the formulations are also microbiologically stable.

Compositions and properties of examples 4a to 4f are given in table 4 (amounts given in % w/w).

TABLE 4

| Recipe (% w/w) | 4a | | 4b | | 4c | | 4d | |
|---|---|---|---|---|---|---|---|---|
| Bacillus amyloliquefaciens | 1 | | 1 | | 1 | | 1 | |
| MBI 600 | | | | | | | | |
| 1,2-Propylene glycol | 59 | | 54 | | 59 | | 80 | |
| Water | 40 | | 40 | | 39.9 | | 19 | |
| Surfactant A | | | 5 | | | | | |
| Xanthan Gum | | | | | 0.1 | | | |
| initial | | | | | | | | |
| Visual evaluation | homogeneous | | homogeneous | | homogeneous | | homogeneous | |
| | opaque liquid | | opaque liquid | | opaque liquid | | opaque liquid | |
| D90 (μm) (with sonication) | 45.7 | (45.4) | 50.1 | (43.1) | 49.8 | (46.4) | 47.6 | (48.0) |
| D50 (μm) (with sonication) | 5.1 | (1.6) | 6.7 | (1.6) | 6.6 | (1.6) | 2.2 | (1.9) |
| viscosity (mPas at 100s − 1) | 12 | | 22 | | 56 | | 35 | |
| cfuig | 8.1E+9 | | 1.4E+10 | | 1.3E+10 | | 1.3E+10 | |
| 14 d 54° C. | | | | | | | | |
| Visual evaluation | flocculation | | flocculation | | homogeneous | | flocculation | |
| | and phase | | and phase | | opaque liquid. | | and phase | |
| | separation, | | separation, | | with slight | | separation, | |
| | sediment, | | sediment, | | syneresis | | sediment, | |
| | red ispersible | | red ispersible | | | | red ispersible | |
| D90 (μm) (with sonication) | 46.7 | (47.6) | 46.7 | (47.6) | 48.3 | (45.7) | 44.9 | (49.9) |
| D50 (μm) (with sonication) | 10.3 | (2.1) | 11.3 | (1.9) | 9.7 | (2.1) | 6.9 | (2.4) |

| viscosity (mPas at 100s − 1) | 20 | 24 | 60 | 42 |
|---|---|---|---|---|
| 1 week 35° C. | | | | |
| cfu/g | 9.6E+9 | 7.4E+9 | 1.2E+10 | 1.4E+10 |
| Recipe | 4e | | 4f | |
| Bacillus amyloliquefaciens | 1 | | 1 | |
| MBI 600 | | | | |
| 1,2-Propylene glycol | 75 | | 80 | |
| Water | 19 | | 18.9 | |
| Surfactant A | 5 | | | |
| Xanthan Gum | | | 0.1 | |
| initial | | | | |
| Visual evaluation | homogeneous | | homogeneous | |
| | opaque liquid | | opaque liquid | |
| D90 (μm) (with sonication) | 56.2 | (44.8) | 55.6 | (39.4) |
| D50 (μm) (with sonication) | 4.8 | (1.6) | 2.3 | (1.7) |
| viscosity (mPas at 100s − 1) | 45 | | 101 | |
| cfu/g | 1.4E+10 | | 1.5E+10 | |
| 14 d 54° C. | | | | |
| Visual evaluation | flocculation | | homogeneous | |
| | and phase | | opaque liquid | |
| | separation, | | with few | |
| | sediment, | | translucent | |
| | redispersible | | spots, easily | |
| | | | redispersible | |
| D90 (μm) (with sonication) | 46.7 | (47.6) | 51.2 | (45.0) |
| D50 (μm) (with sonication) | 13.7 | (2.1) | 8.6 | (1.9) |

| | | |
|---|---|---|
| viscosity (mPas at 100s − 1) | 49 | 121 |
| 1 week 35° C. | | |
| cfu/g | 1.6E+10 | 1.3E+10 |

### Examples 5a to 5d: Preparation of Microbiologically and Physically Stable Spore Dispersions with Alternative Glycol and Thickening Agents

The samples 5a to 5c were prepared as follows: First, a 10% premix of spore powder of Bacillus amyloliquefaciens MBI 600 was dispersed in a mixture of 80 parts of water and 10 parts of polyethylene glycol with a mean molecular weight of 200 g/mol (from OH number) (PEG 200). A thickener premix was added to the spore powder premix and the complete mixture was homogenized with a rotor-stator equipment until a final particle size of D50 of around 2 μm was reached. In the case of fumed silica, the thickener premix consisted of 9.1% thickening agent, 60.6% PEG 200 and 30.3% water. In the case of Magnesium Aluminum Silicate the thickener premix consisted of 9.1% thickening agent in 90.9% water.

Finally, the remaining amount of polyethylene glycol and water were added and the sample stirred until homogeneous.

The sample 5d was prepared as follows:

First, a 10% premix of spore powder was dispersed in a mixture of 80 parts of water and 10 parts of polyethylene glycol with a mean molecular weight of 200 (PEG 200). A thickener premix was added to the spore powder premix and the complete mixture was homogenized with a rotor-stator equipment until a final particle size of D50 of around 2 μm was reached.

Finally, the remaining amount of polyethylene glycol, water and antifoam were added and the sample stirred until homogeneous.

Compositions and properties of examples 5a to 5d are given in table 5 (amounts given in grams [g]).

The samples were stored for 2 weeks at 40° C. They stayed homogeneous showing only slight syneresis and could be completely rehomogenized with only three inversions. Also, no odor or coloring was developed, showing that the formulations are microbiologically stable.

TABLE 5

| Recipe (g) | 5a | | 5b | | 5c | | 5d | |
|---|---|---|---|---|---|---|---|---|
| Bacillus amyloliquefaciens | 30 | | 30 | | 30 | | 30 | |
| MBI 600 | | | | | | | | |
| PEG 200 | 600 | | 600 | | 600 | | 604 | |
| Water | 418 | | 418 | | 418 | | 389.5 | |
| Fumed Silica | 10 | | | | | | 10 | |
| Magnesium Aluminum | | | 10 | | | | | |
| Silicate A | | | | | | | | |
| Magnesium Aluminum | | | | | 10 | | | |
| Silicate B | | | | | | | | |
| Surfactant A | | | | | | | 19.5 | |
| Antifoam vegetable | | | | | | | 5.0 | |
| oil basis | | | | | | | | |
| initial | | | | | | | | |
| Visual evaluation | homogeneous | | homogeneous | | homogeneous | | homogeneous | |
| | opaque liquid | | opaque liquid | | opaque liquid | | opaque liquid | |
| D90 (μm) (with sonication) | 46.9 | (48.1) | 44.6 | (42.9) | 45.3 | (43.0) | 44.0 | (48.8) |
| D50 (μm) (with sonication) | 1.7 | (1.5) | 2.9 | (2.0) | 2.9 | (1.6) | 1.7 | (1.5) |

| | | | | |
|---|---|---|---|---|
| viscosity (mPas at 100s − 1) | 157 | 151 | 187 | 137 |

2 weeks at 40° C.

| Visual evaluation | slight synere- | | slight synere- | | slight synere- | | slight synere- | |
|---|---|---|---|---|---|---|---|---|
| | sis, easily | | sis, easily | | sis, easily | | sis, easily | |
| | red ispersible | | red ispersible | | red ispersible | | red ispersible | |
| D90 (μm) (with sonication) | 48.1 | (48.9) | 44.4 | (41.9) | 45.2 | (45.5) | 43.8 | (46.5) |
| D50 (μm) (with sonication) | 1.9 | (1.6) | 4.0 | (2.2) | 2.1 | (1.8) | 2.2 | (1.9) |

| | | | | |
|---|---|---|---|---|
| viscosity (mPas at 100s − 1) | 120 | 112 | 161 | 134 |

### Examples 6a to 6d: Preparation of Microbiologically and Physically Stable Bacillus amyloliquefaciens Spore Dispersions with Alternative Glycol and Thickening Agents, 12 Weeks 40° C. Shelf Life

For examples 6a to 6d, Bacillus amyloliquefaciens MBI 600 spore powder was dispersed in pure water to give a 10% spore premix. To 120 grams of this spore premix complete the samples, 40 grams of thickener premix containing 8 parts of Xanthan Gum in 392 parts of water, were added. To finalize the samples, 193.6 g of the respective glycol and 46.4 g of water were added.

Compositions and properties of examples 6a to 6d are given in table 6 (amounts given in grams [g]).

The samples were stored for 12 weeks at 40° C. They stayed homogeneous showing only slight syneresis and could be completely rehomogenized with only three inversions. Also, no odor or coloring was developed, showing that the formulations are microbiologically stable. Also, a determination of cfu every 4 weeks during storage showed that the spores stay viable in this mixture at elevated temperatures.

TABLE 6

| | 6a | 6b | 6c | 6d |
|---|---|---|---|---|
| Bacillus amyloliquefaciens | 3 | 3 | 3 | 3 |
| MBI 600 | | | | |
| Ethylene glycol | 48.4 | | | |
| 1.3-Propylene glycol | | 48.4 | | |
| Triethylene glycol | | | 48.4 | |
| PEG 200 | | | | 48.4 |
| Xanthan Gum | 0.2 | 0.2 | 0.2 | 0.2 |
| Water | 48.4 | 48.4 | 48.4 | 48.4 |

initial

| | | | | |
|---|---|---|---|---|
| Homogeneous | yes | yes | yes | yes |
| Serum/redispersible | no/— | no/— | no/— | no/— |
| Sediment/redispersible | no/— | no/— | no/— | no/— |
| Cfu/g | 3.5E+10 | 3.1E+10 | 3.5E+10 | 3.7E+10 |

4 weeks at 40° C.

| | | | | |
|---|---|---|---|---|
| Homogeneous | no | no | no | no |
| Serum/redispersible | yes/yes | yes/yes | yes/yes | yes/yes |
| Sediment/redispersible | no/— | no/— | no/— | no/— |
| Cfu/g | 2.9E+10 | 3.2E+10 | 3.1E+10 | 3.1E+10 |

8 weeks at 40° C.

| | | | | |
|---|---|---|---|---|
| Homogeneous | no | no | no | no |
| Serum/redispersible | yes/yes | yes/yes | yes/yes | yes/yes |
| Sediment/redispersible | no/— | no/— | no/— | no/— |
| Cfu/g | 2.4E+10 | 2.5 E+10 | 3.1E+10 | 3.1E+10 |

12 weeks at 40° C.

| | | | | |
|---|---|---|---|---|
| Homogeneous | no | no | no | no |
| Serum/redispersible | yes/yes | yes/yes | yes/yes | yes/yes |
| Sediment/redispersible | no/— | no/— | no/— | no/— |
| Cfu/g | 1.5E+10 | 1.7E+10 | 2.1E+10 | 2.0E+10 |

### Examples 7a to 7d: Preparation of Microbiologically and Physically Stable Bacillus subtilis BU 1814 Spore Dispersions with Alternative Glycol and Thickening Agents, 12 Weeks 40° C. Shelf Life

For examples 6a to 6d, Bacillus subtilis BU1814 spore powder was dispersed in pure water to give a 10% spore premix. To 120 grams of this spore premix complete the samples, 40 grams of thickener premix containing 8 parts of Xanthan Gum in 392 parts of water, were added. To finalize the samples, 193.6 g of the respective glycol and 46.4 g of water were added.

Compositions and properties of examples 7a to 7d are given in table 7 (amounts given in grams [g]).

The samples were stored for 12 weeks at 40° C. They stayed homogeneous showing only slight syneresis and could be completely rehomogenized with only three inversions. Also, no odor or coloring was developed, showing that the formulations are microbiologically stable. Also, a determination of cfu every 4 weeks during storage showed that the spores stay viable in this mixture at elevated temperatures.

TABLE 7

| Recipe (g) | 7a | 7b | 7c | 7d |
|---|---|---|---|---|
| Bacillus amyloliquefaciens | 3 | 3 | 3 | 3 |
| MBI 600 | | | | |
| 1.2-Propylene glycol | 48.4 | | | |
| 1.2-Butylene glycol | | 48.4 | | |
| Triethylene glycol | | | 48.4 | |
| PEG 200 | | | | 48.4 |
| Xanthan Gum | 0.2 | 0.2 | 0.2 | 0.2 |
| Water | 48.4 | 48.4 | 48.4 | 48.4 |

initial

| | | | | |
|---|---|---|---|---|
| Homogeneous | yes | yes | yes | yes |
| Serum/redispersible | no/— | no/— | no/— | no/— |
| Sediment/redispersible | no/— | no/— | no/— | no/— |
| Cfu/g | 1.4E+10 | 1.8E−10 | 1.4E+10 | 1.4E+10 |

4 weeks at 40° C.

| | | | | |
|---|---|---|---|---|
| Homogeneous | no | no | no | no |
| Serum/redispersible | yes/yes | yes/yes | yes/yes | yes/yes |
| Sediment/redispersible | no/— | no/— | no/— | no/— |
| Cfu/g | 2.2E+10 | 2.2E+10 | 1.6E+10 | 1.7E+10 |

8 weeks at 40° C.

| | | | | |
|---|---|---|---|---|
| Homogeneous | no | no | no | No |
| Serum/redispersible | yes/yes | yes/yes | yes/yes | yes/yes |
| Sediment/redispersible | no/— | no/— | no/— | no/— |
| Cfu/g | 1.1E+10 | 1.1E+10 | 1.2E+10 | 1.0E+10 |

12 weeks at 40° C.

| | | | | |
|---|---|---|---|---|
| Homogeneous | no | no | no | no |
| Serum/redispersible | yes/yes | yes/yes | yes/yes | yes/yes |
| Sediment/redispersible | no/— | no/— | no/— | no/— |
| Cfu/g | 1.1E+10 | 1.9E+10 | 1.3E+10 | 9.8E+9 |

1. A process for making a liquid dispersion formulation comprising
a) at least one type of bacterium spores,
b) an aqueous continuous phase comprising at least one glycol, wherein said glycol is comprised in the formulation in a weight amount that exceeds the weight amount of water,
c) optionally at least one surface active compound S, and
d) optionally further auxiliaries,
comprising:
A. providing a solid powder of the bacterium spores,
B1. dispersing said spores in a continuous phase comprising the at least one glycol, wherein a weight ratio of said at least one glycol to water is below or equal to 1:1,
B2. adding further glycol to the dispersion obtained in step B1. to obtain a ratio of said at least one glycol to water from 4:1 to 1.2:1,
C. optionally adding at least one surfactant S,
D. optionally adding at least one thickener,
E. optionally adding further auxiliaries,
wherein steps C, D and E can be carried out at any time during the process, and where the term “glycol” shall include glycerol.

2. The process according to claim 1, wherein said formulation comprises at least 40 wt % of said at least one glycol based on the formulation and wherein the formulation comprises at least 15% but maximally 40% of water.

3. The process according to claim 1, wherein the formulation comprises at least one nonionic surfactant S.

4. The process according to claim 1, wherein said surfactant S is an ethoxylate of a sugar alcohol.

5. The process according to claim 1, wherein said bacterium spores are present in the formulation in a form of solid particles having an average particle size of 1 to 25 μm.

6. The process according to claim 1, wherein said glycol is selected from 1,2-propylene glycol, ethylene glycol, diethylene glycol, 1,2-butylene glycol, polyethylene glycol having an average molecular mass Mn of 150 to 600 g/mol, glycerol.

7. The process according to claim 1, wherein said at least one bacterium is selected from Bacillus subtilis, Bacillus velezensis, Bacillus amyloliquefaciens, Bacillus firmus, Bacillus pumilus, Bacillus simplex, Paenibacillus polymyxa, Bacillus megaterium, Bacillus aryabhattai, Bacillus thuringiensis, Bacillus megaterium, Bacillus aryabhattai, Bacillus altitudinis, Bacillus mycoides, Bacillus toyonensis, Bacillus safensis, Bacillus methylotrophicus, Bacillus mojavensis, Bacillus psychrosaccharolyticus, Bacillus galliciensis, Bacillus lentus, Bacillus siamensis, Bacillus tequilensis, Bacillus firmus, Bacillus aerophilus, Bacillus altitudinis, Bacillus stratosphericus, Bacillus velezensis, Brevibacillus brevis, Brevibacillus formosus, Brevibacillus laterosporus, Brevibacillus nitrificans, Brevibacillus agri, Brevibacillus borstelensis, Lysinibacillus xylanilyticus, Lysinibacillus parviboronicapiens, Lysinibacillus sphaericus, Lysinibacillus fusiformis, Lysinibacillus boronitolerans, Paenibacillus alvei, Paenibacillus Validus, Paenibacillus amylolyticus, Paenibacillus lautus, Paenibacillus peoriae, Paenibacillus tundrae, Paenibacillus daejeonensis, Paenibacillus alginolyticus, Paenibacillus pini, Paenibacillus odorifer, Paenibacillus endophyticus, Paenibacillus xylanexedens, Paenibacillus illinoisensis, Paenibacillus thiaminolyticus, Paenibacillus barcinonensis, Sporosarcina globispora, Sporosarcina aquimarina, Sporosarcina psychrophila, Sporosarcina pasteurii, and Sporosarcina saromensis.

8. The process according to claim 1, wherein said at least one bacterium is selected from Bacillus subtilis, Bacillus velezensis, Bacillus amyloliquefaciens, Bacillus firmus, Bacillus pumilus, Bacillus simplex, and Paenibacillus polymyxa.

9. The process according to claim 1, further comprising xanthan gum.

10. The process according to claim 1, further comprising magnesium aluminum silicate, bentonite, attapulgite, or silica as a thickener.
